(19) United States
(12) Patent Application Publication
(10) Pub. No.: US 2012/0031812 A1
(43) Pub. Date: Feb. 9, 2012

(54) METHOD AND SYSTEM FOR MODIFYING A FUEL

(76) Inventor: Raymond Edward Paggi, Winchester, VA (US)

(21) Appl. No.: 13/195,584

(22) Filed: Aug. 1, 2011

Related U.S. Application Data
(60) Provisional application No. 61/370,333, filed on Aug. 3, 2010.

(51) Int. Cl. C10G 32/02; B06B 1/00; C10L 1/00

(52) U.S. Cl. 208/133; 422/128; 44/307; 208/196

(57) ABSTRACT

A method for increasing a cetane number of fuel may comprise using a sonication device to expose fuel flowing through the sonication device to ultrasonic wave energy for a period of time, thereby increasing the cetane number of the fuel. The cetane number of the fuel may be increased just prior to supplying the fuel to an end user. An apparatus for increasing a cetane number of fuel may comprise a fuel dispensing system and a sonication device coupled to the fuel dispensing system. The sonication device may include a housing disposed within the fuel dispensing system, a flow conduit disposed through the housing, and one or more transducers operable to provide ultrasonic wave energy to fuel flowing through the flow conduit.

### CROSS REFERENCE TO RELATED APPLICATIONS

This application claims benefit of co-pending U.S. Provisional Patent Application Ser. No. 61/370,333, filed Aug. 3, 2010, the contents of which are incorporated herein by reference in its entirety.

### BACKGROUND OF THE INVENTION

1. Field of the Invention

Embodiments of the invention generally relate to methods and systems for modifying a fuel at a dispensing system while pumping the fuel into a pipeline, a storage tank, and/or a motor vehicle. Particularly, embodiments of the invention relate to modifying the fuel by increasing the cetane number of the fuel using a sonication device that is built into or otherwise connected to the dispensing system. More particularly, embodiments of the invention relate to increasing the cetane number of the fuel using ultrasonic energy, thereby improving the fuel's ignition quality, fuel conversion efficiency, and exhaust emissions.

2. Description of the Related Art

The Cetane Number (“CN”) of a diesel fuel is well known for its impact on ignition quality, fuel conversion efficiency and exhaust emissions. CN is a measurement of the combustion quality of the fuel during compression ignition. Specifically, CN is a measure of the fuel's ignition delay, i.e. the time period between the start of injection and the start of combustion of the fuel. Fuels with high CNs will have shorter ignition delay periods than fuels with low CNs. Fuels with higher CNs allow engine start-up more readily, produce less smoke, improve fuel economy, and can also lower CO2 and NOx exhaust emissions. The current ASTM specification for CN is 40, and diesel fuels in the market typically have CNs in the range of about 42 to about 46. An increase of two to three CNs can reduce fuel consumption by over 10 percent and significantly reduce particulate emission in the exhaust.

Historically, refineries have been limited by the amount of CN that can be generated in a fuel because of the type of processing units that are used during the refining process. Specific chemical streams that are mixed with the fuel stream during the refining process inhibit or reduce the CN of the fuel stream. Therefore, other avenues have been researched for raising the CN of fuels post-refinery processing. One method of increasing the CN of fuel includes the use of additives. Ethyl hexyl nitrate and di-tert-butyl peroxide are commonly used additives that can raise the CN of fuel. However, the cost of using such bulk additives, including storage, transportation, and handling, may greatly outweigh the benefits.

Therefore, there is a need for systems and methods that can be used to raise the CN of a fuel post-refinery processing.

### SUMMARY OF THE INVENTION

In one embodiment, a method of increasing a cetane number of fuel may comprise flowing fuel through a sonication device; exposing the fuel to ultrasonic wave energy; increasing the cetane number of the fuel; and supplying the fuel having the increased cetane number to an end user.

In one embodiment, an apparatus for increasing a cetane number of fuel may comprise a fuel dispensing system and a sonication device coupled to the fuel dispensing system. The sonication device may include a housing disposed within the fuel dispensing system, a flow conduit disposed through the housing, and one or more transducers operable to provide ultrasonic wave energy to fuel flowing through the flow conduit.

In one embodiment, a method of supplying a fuel to a fuel-containment device may comprise positioning the fuel-containment device adjacent to a fuel dispensing system; retrieving the fuel from a fuel source using the fuel dispensing system; and treating the fuel using a sonication device, thereby increasing a cetane number of the fuel. The method may further comprise supplying the treated fuel to the fuel-containment device and moving the fuel-containment device away from the fuel dispensing system after supplying the treated fuel to the fuel-containment device. In one embodiment, the fuel-containment device may include a land, air, marine vehicle. In one embodiment, the fuel-containment device may include a hand-held container. In one embodiment, the fuel source may include a storage tank, and the treated fuel may be directly supplied to an engine of the vehicle, the hand-held container, and/or other fuel-containment devices.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an “in-line” sonication system according to one embodiment.

FIG. 2 illustrates a schematic view of a sonication device and a fuel dispensing system according to one embodiment.

### DETAILED DESCRIPTION

Embodiments of the invention include methods and apparatus for increasing the Cetane Number (“CN”) of a fuel. Embodiments of the invention may be used with all types and grades of diesel fuel, including but not limited to K1, K2, D1, D2, D3, D4, D5, D6, and biodiesel. Diesel fuel may include any liquid fuel used in a diesel engine, which is an internal combustion engine that uses the heat of compression to initiate ignition to burn the fuel that is injected into the engine's combustion chamber during a compression stroke. The term fuel as used herein, however, may include any liquid fuel and is not limited to diesel fuel.

In general, a fuel dispensing system may be configured with a sonication device to raise the CN of a fuel prior to reaching an end user. While the fuel is flowing to the end user, ultrasonic wave energy is applied to the fuel to increase the CN of the fuel. The fuel dispensing system may be configured to retrieve fuel from a fuel source, direct the fuel through the sonication device, and supply the fuel to the end user. In one embodiment, the end user may suitably include a pipeline, a storage tank, a (land, air, marine) vehicle, a generator, and/or other fuel/motor-powered devices.

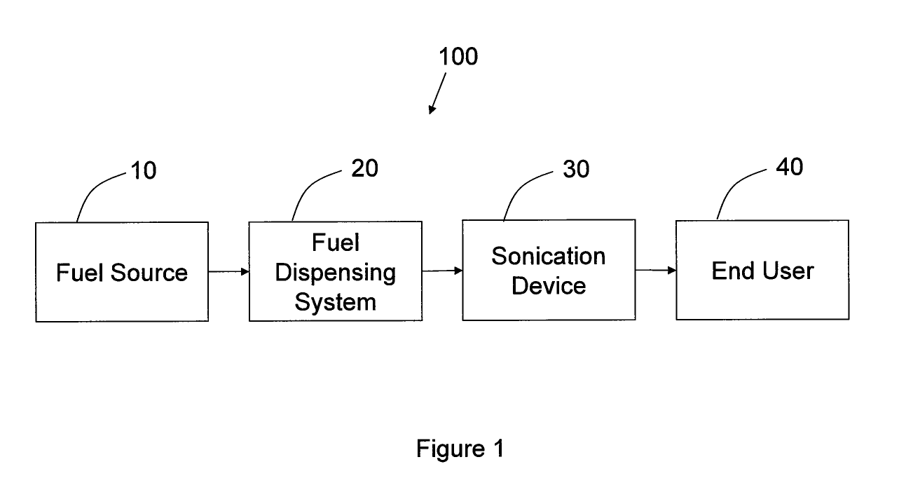

FIG. 1 illustrates one embodiment of a system 100, comprising a fuel source 10, a fuel dispensing system 20, a sonication device 30, and an end user 40. The assembly 100 utilizes an “in-line” sonication process to raise the CN of fuel provided from the fuel source 10 prior to be being supplied to the end user 40. The sonication device 30 may be fully integrated with the fuel dispensing system 20 so that it automatically operates upon operation of the fuel dispensing system 20.

In one embodiment, the fuel source 10 may be a storage tank that is in communication with the fuel dispensing system 20. For example, the fuel source 10 may be an underground storage tank at a fuel station where consumers purchase fuel for a vehicle. In another example, the fuel source 10 may be a fuel truck used for storing and/or transporting fuel to various locations, including fuel stations and storage facilities, and/or for supplying fuel directly to another fuel-powered vehicle or device. In another example, the fuel source 10 may be a pipeline from a refinery for supplying fuel to various end users. Fuel provided from the fuel source 10 is directed through the fuel dispensing system 20 and the sonication device 30 prior to receipt by the end user 40.

In one embodiment, the fuel dispensing system 20 may include any type of system operable for delivering fuel to the end user 40. Numerous flow control devices, such as pumps, valves, and flow conduits may be part of the fuel dispensing system 20 to facilitate fuel flow from the fuel source 10 to the end user 40 in a safe, controlled, and easy-to-operate manner. For example, an outlet of the fuel dispensing system 20 may be coupled to an inlet of a pipeline, storage tank, vehicle, and/or other (fuel-powered) devices for communication of fuel from the fuel source 10 to the end user 40. In one embodiment, the fuel dispensing system 20 may include a fuel pump that is located at a fuel station for supplying fuel to a vehicle. In one embodiment, the fuel dispensing system 20 may include a fuel pump that is located at a refinery for supplying fuel to transport vehicles for delivery of the fuel to a retail outlet or a fleet of tankers. In one embodiment, the fuel dispensing system 20 may include any type of pump and/or valve system operable to control the flow of fuel from a pipeline.

In one embodiment, the sonication device 30 may include any type of device that is operable to generate and apply high-frequency sound waves to the fuel to increase the CN of the fuel. In one embodiment, the sonication device 30 may include a housing, one or more flow tubes disposed within the housing, and one or more transducers coupled to the housing and/or flow tubes that are operable to generate ultrasonic waves in the fuel flowing through the flow tubes. In one embodiment, piezoelectric or magnetostrictive type transducers may be used. The sonication device 30 may also include a controller, such as a wave generator, that is electrically coupled to the transducers and is operable deliver high-frequency alternating current to excite the transducers. An input signal of a predetermined or variable frequency and voltage is generated by the controller and sent to the transducers to produce ultrasonic waves in the fuel flowing through the sonication device 30. The ultrasonic waves may be changed by the input signal provided by the controller. In one embodiment, the frequency or range of frequencies of the ultrasonic waves provided by the sonication device 30 may be varied, adjusted, and/or selected so that the most efficient frequency is matched to the specification of a particular fuel. In one embodiment, the sonication device 30 may be retrofit to various existing fuel dispensing systems 20, such as pipelines and fuel pumps at retail fueling stations.

The term “ultrasonic” as used herein may include any frequency greater than 10 kHz. In one embodiment the sonication device 30 is operable to expose the fuel flowing through the sonication device 30 to ultrasonic waves having a frequency in a range of about 10 kHz to about 400 kHz, in a range of about 15 kHz to about 200 kHz, in a range of about 20 kHz to about 100 kHz, and in a range of about 30 kHz to about 50 kHz. In one embodiment the sonication device 30 is operable to expose the fuel flowing through the sonication device 30 to ultrasonic waves having a frequency of about 44 kHz.

In operation, the fuel from the fuel source 10 may be retrieved using the fuel dispensing system 20 at the request of the end user 40. The fuel dispensing system 20 may be operated to direct the fuel to the sonication device 30 and the end user 40. Operation of the fuel dispensing system 20 may automatically initiate operation of and/or operate the sonication device 30. While the fuel is flowing through the sonication device 30, it is exposed to ultrasonic waves to raise the CN of the fuel prior to reaching the end user 40. In one embodiment, the fuel may be directed through one or more flow tubes disposed within a housing of the sonication device 30 via the fuel dispensing system 20. The flow tubes may be coupled with one or more transducers operable to provide ultrasonic wave energy to the fuel, thereby increasing the CN of the fuel.

In one embodiment, the fuel flowing through the sonication device 30 may be exposed to ultrasonic wave energy for a period of time in a range of about 1 second to about 15 minutes, in a range of about 3 seconds to about 10 minutes, in a range of about 5 seconds to about 4 minutes, in a range of about 10 seconds to about 3 minutes, and in a range of about 30 seconds to about 2 minutes.

In one embodiment, the fuel flowing through the sonication device 30 may be supplied at a flow rate in a range of about 0.5 gallons per minute to about 300 gallons per minute, in a range of about 1 gallon per minute to about 200 gallons per minute, in a range of about 5 gallons per minute to about 100 gallons per minute, and in a range of about 10 gallons per minute to about 50 gallons per minute.

In one embodiment, the CN of the fuel flowing through the sonication device 30 may be increased in a range of about 1 percent to about 20 percent, in a range of about 2 percent to about 15 percent, in a range of about 3 percent to about 10 percent, and in a range of about 5 percent to about 10-15 percent.

In one example, a fuel sample comprising a grade D2 (ultra-low sulfur) diesel fuel having an initial CN of 43.94 was exposed to ultrasonic wave energy for 5 minutes at a 42 kHz frequency, which raised the CN to 46.47. In another example, a fuel sample comprising 100 percent biodiesel and having an initial CN of 48.71 was exposed to ultrasonic wave energy for 5 minutes at a 42 kHz frequency, which raised the CN to 51.51. In another example, a fuel sample comprising 100 percent biodiesel and having an initial CN of 52.6 was exposed to ultrasonic wave energy for 5 minutes at a 42 kHz frequency, which raised the CN to 62.33. In another example, a fuel sample comprising 100 percent biodiesel and having an initial CN of 52.6 was exposed to ultrasonic wave energy for 5 minutes at a 25 kHz frequency, which raised the CN to 61.99. In one embodiment, the compositions of the fuels described herein may remain unchanged after exposure to any amount of ultrasonic wave energy for any period of time.

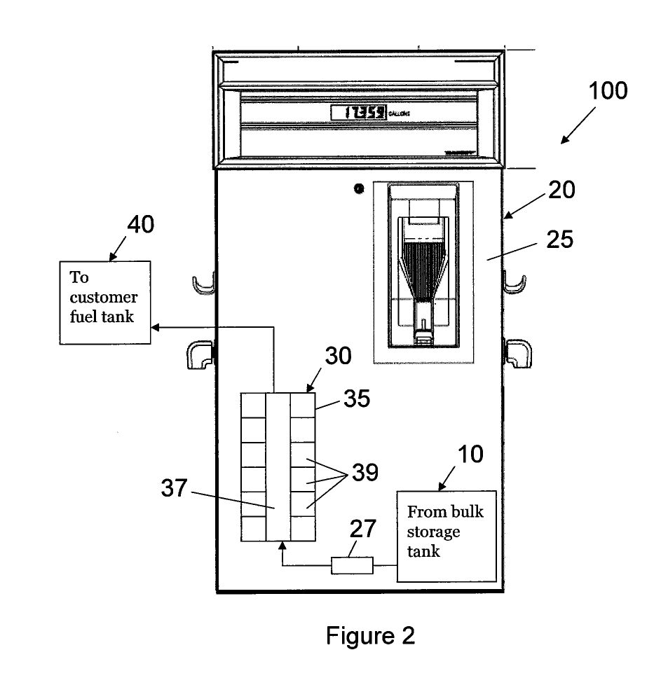

FIG. 2 illustrates a schematic view of the system 100 according to one embodiment. As illustrated, the fuel source 10 is an underground bulk storage tank that is in communication with the fuel dispensing system 20, which is a fuel pump that can be located at any type of (retail) fueling station. The sonication device 30 is disposed within a housing 25 of the fuel dispensing system 20, and is in communication with the fuel source 10 via the fuel dispensing system 20. The sonication device 30 includes a housing 35, a conduit 37, such as a flow tube, forming a fuel flow path through the housing 35, and one or more transducers 39 surrounding the conduit 37 and disposed within the housing 35. Upon operation of the fuel dispensing system 20, fuel is retrieved from the fuel source 10 and directed through the conduit 37 of the sonication device 30. In one embodiment, a pump assembly 27 of the fuel dispensing system 20 may be used to pump fuel from the fuel source 10, through the sonication device 30, to the end user 40. While the fuel is flowing through the conduit 37, the one or more transducers 39 may be actuated to provide ultrasonic wave energy to the fuel. The exposure of the fuel to the ultrasonic wave energy raises the CN of the fuel. The modified fuel may then be supplied to the end user 40, such as to a customer's motor vehicle fuel tank.

In one embodiment, to increase the exposure time of the fuel to the ultrasonic wave energy, a single sonication device 30 may be used, which is configured to expose the fuel to the ultrasonic wave energy for at least a pre-determined time frame. In one embodiment, multiple sonication devices 30 may be used to increase the exposure time, which may be located in a series and/or in parallel with the fuel dispensing system 20 to provide continuous fuel delivery. In one embodiment, the sonication device 30 and/or the fuel dispensing system 20 may be configured so that the fuel flow path is looped to direct fuel through the sonication device 30 multiple times to increase the exposure time of the fuel to the ultrasonic wave energy.

In one embodiment, the CN of the modified fuel may permanently remain at the increased CN. In one embodiment, the CN of the modified fuel may temporarily remain at the increased CN for a pre-determined amount of time, such as about two weeks. In one embodiment, the CN of the modified fuel may begin to decrease after a pre-determined amount of time. In one embodiment, the CN of the modified fuel may remain at the increased CN for a pre-determined amount of time depending on the time of exposure of the fuel to the ultrasonic wave energy, the frequency of the ultrasonic wave energy, the power of the ultrasonic wave energy, and/or the flow rate of the fuel flowing through the sonication device 30. In one embodiment, the composition of the fuel may remain the same before, during, and/or after exposure to the ultrasonic wave energy.

In one embodiment, a method of increasing the cetane number of fuel may comprise flowing fuel through a sonication device; exposing the fuel to ultrasonic wave energy, thereby increasing the cetane number of the fuel; and supplying the fuel having an increased cetane number to an end user. The method may further comprise automatically operating the sonication device upon operation of the fuel dispensing system. The fuel may be diesel fuel including at least one of K1, K2, D1, D2, D3, D4, D5, and D6 grade diesel fuel, and/or biodiesel. The sonication device may include one or more transducers for generating ultrasonic wave energy. The fuel temporarily retains the increased cetane number for a pre-determined time period, such as about two weeks for example. The cetane number of the fuel having the increased cetane number may begin to decrease after a pre-determined time period. The sonication device may be configured to expose fuel flowing through a flow conduit to ultrasonic wave energy for a period of time including a range of about 5 seconds to about 5 minutes, a range of about 20 seconds to about 4 minutes, a range of about 30 seconds to about 3 minutes, a range of about 40 seconds to about 2 minutes, or a range of about 50 seconds to about 1 minute. The sonication device may be configured to flow fuel through the flow conduit at a flow rate in a range of about 0.5 gallons per minute to about 300 gallons per minute, a range of about 1 gallon per minute to about 200 gallons per minute, a range of about 5 gallons per minute to about 100 gallons per minute, or a range of about 10 gallons per minute to about 50 gallons per minute. The sonication device may be configured to increase the cetane number of the fuel flowing through the sonication device in a range of about 1 percent to about 20 percent, a range of about 2 percent to about 15 percent, a range of about 3 percent to about 10 percent, or a range of about 5 percent to about 10-15 percent. The end user may include at least one of a land, air, and marine transport vehicle.

While the foregoing is directed to embodiments of the invention, other and further embodiments of the invention may be devised without departing from the basic scope thereof, and the scope thereof is determined by the claims that follow.

1. A method of increasing a cetane number of fuel, comprising:
flowing fuel through a sonication device;
exposing the fuel to ultrasonic wave energy, thereby increasing the cetane number of the fuel; and
supplying the fuel having the increased cetane number to an end user.

2. The method of claim 1, further comprising operating a fuel dispensing system to retrieve the fuel from a fuel source to supply to the end user.

3. The method of claim 2, further comprising directing the fuel from the fuel source to the sonication device.

4. The method of claim 2, wherein the sonication device is disposed within a housing of the fuel dispensing system.

5. The method of claim 2, wherein the fuel source includes at least one of a storage tank, a fuel storage/transport vehicle, and a pipeline, and wherein the end user includes at least one of a storage tank, a vehicle, a pipeline, and a fuel-powered device.

6. The method of claim 2, wherein the fuel dispensing system includes a pump assembly operable to control fuel flow from at least one of a storage tank, a fuel storage/transport vehicle, a pipeline, and a fuel station.

7. The method of claim 1, wherein the fuel flowing through the sonication device includes diesel fuel.

8. The method of claim 1, further comprising flowing the fuel through a flow tube of the sonication device, and exposing the fuel to ultrasonic wave energy using one or more transducers while flowing the fuel through the flow tube.

9. The method of claim 1, wherein the ultrasonic wave energy includes a frequency within a range of about 10 kHz to about 400 kHz, a range of about 15 kHz to about 200 kHz, a range of about 20 kHz to about 100 kHz, a range of about 30 kHz to about 50 kHz, or a frequency of about 44 kHz.

10. The method of claim 1, further comprising exposing the fuel to ultrasonic wave energy for a time period within a range of about 5 seconds to about 5 minutes, a range of about 20 seconds to about 4 minutes, a range of about 30 seconds to about 3 minutes, a range of about 40 seconds to about 2 minutes, or a range of about 50 seconds to about 1 minute.

11. The method of claim 1, further comprising flowing the fuel through the sonication device at a flow rate within a range of about 0.5 gallons per minute to about 300 gallons per minute, a range of about 1 gallon per minute to about 200 gallons per minute, a range of about 5 gallons per minute to about 100 gallons per minute, or a range of about 10 gallons per minute to about 50 gallons per minute.

12. The method of claim 1, further comprising increasing the cetane number of the fuel flowing through the sonication device within a range of about 1 percent to about 20 percent, a range of about 2 percent to about 15 percent, a range of about 3 percent to about 10 percent, or a range of about 5 percent to about 10-15 percent.

13. The method of claim 1, wherein the fuel having the increased cetane number permanently remains at the increased cetane number or temporarily retains the increased cetane number for a pre-determined time period.

14. The method of claim 1, further comprising controlling at least one of a time period of exposure of the fuel to the ultrasonic wave energy, a frequency of the ultrasonic wave energy, a power of the ultrasonic wave energy, and a flow rate of the fuel flowing through the sonication device to control an amount of increase of the cetane number of the fuel flowing through the sonication device.

15. The method of claim 1, further comprising adjusting or varying a frequency of the ultrasonic wave energy while flowing the fuel through the sonication device.

16. The method of claim 1, further comprising selecting a frequency of the ultrasonic wave energy based on a type of fuel flowing through the sonication device.

17. An apparatus for increasing a cetane number of fuel, comprising:
a fuel dispensing system; and
a sonication device coupled to the fuel dispensing system, wherein the sonication device comprises:
a housing disposed within the fuel dispensing system;
a flow conduit disposed through the housing; and
one or more transducers operable to provide ultrasonic wave energy to fuel flowing through the flow conduit.

18. The apparatus of claim 17, wherein the fuel dispensing system includes a fuel pump in communication with a fuel source for supplying fuel to an end user, and wherein the fuel source includes at least one of a storage tank, a fuel storage/transport vehicle, and a pipeline.

19. The apparatus of claim 17, wherein the fuel dispensing system includes a pump assembly operable to control fuel flow from at least one of a storage tank, a fuel storage/transport vehicle, a pipeline, and a fuel station.

20. The apparatus of claim 17, wherein the transducers include at least one of a piezoelectric or magnetostrictive type transducer.

21. The apparatus of claim 17, wherein the ultrasonic wave energy includes a frequency within a range of about 10 kHz to about 400 kHz, in a range of about 15 kHz to about 200 kHz, in a range of about 20 kHz to about 100 kHz, in the range of about 30 kHz to about 50 kHz, or a frequency of about 44 kHz.

22. The apparatus of claim 17, wherein the fuel dispensing system is configured to supply fuel to an end user comprising at least one of a storage tank, a vehicle, a pipeline, and a fuel-powered device.

23. The apparatus of claim 17, further comprising a controller configured to adjust a frequency of the ultrasonic wave energy provided by the transducers, vary a frequency of the ultrasonic wave energy provided by the transducers, or select a frequency of the ultrasonic wave energy provided by the transducers based on a type of fuel flowing through the sonication device.

24. The apparatus of claim 17, further comprising a controller configured to operate the fuel dispensing system and the sonication device.

25. A method of supplying a fuel to a fuel-containment device, comprising:
positioning the fuel-containment device adjacent to a fuel dispensing system;
retrieving the fuel from a fuel source using the fuel dispensing system;
treating the fuel using a sonication device, thereby increasing a cetane number of the fuel; and
supplying the treated fuel to the fuel-containment device.

26. The method of claim 25, further comprising coupling an outlet of the fuel dispensing system with an inlet of the fuel-containment device to supply the treated fuel to the fuel-containment device.

27. The method of claim 26, further comprising moving the fuel-containment device away from the fuel dispensing system after supplying the treated fuel.

28. The method of claim 27, wherein the fuel-containment device includes a vehicle, and further comprising powering the vehicle using the treated fuel.

29. The method of claim 25, wherein the fuel source includes a storage tank, wherein the fuel-containment device includes a vehicle, and wherein supplying the treated fuel to the vehicle includes directly fueling a stationary engine of the vehicle.

30. The method of claim 25, wherein the fuel source includes a storage tank, wherein the fuel-containment device includes a hand-held container, and wherein supplying the treated fuel to the hand-held container includes directly fueling the hand-held container.
